(19) United States
(12) Patent Application Publication
(10) Pub. No.: US 2025/0096633 A1
(43) Pub. Date: Mar. 20, 2025

(54) INSULATOR STRUCTURE

(71) Applicants: HONDA MOTOR CO., LTD., Tokyo (JP); Matsuo Industries, Inc., Obu-shi (JP)

(72) Inventors: Shuhei Tanaka, Wako-shi (JP); Atsushi Kubota, Wako-shi (JP); Ryuzo Sakamoto, Wako-shi (JP); Shogo Takano, Wako-shi (JP); Keiya Nimura, Wako-shi (JP); Shigetoshi Yamashita, Obu-shi (JP); Hiromu Nakai, Obu-shi (JP)

(21) Appl. No.: 18/809,513

(22) Filed: Aug. 20, 2024

(30) Foreign Application Priority Data
Sep. 20, 2023 (JP) 2023-152738

(51) Int. Cl. H02K 3/52

(52) U.S. Cl. CPC H02K 3/527; H02K 2203/12; H02K 2213/03

(57) ABSTRACT

An insulator includes: an outer circumferential piece; an inner circumferential piece that faces the outer circumferential piece in a teeth portion axis direction; and a side wall portion that connects the outer circumferential piece to the inner circumferential piece, wherein a space surrounded by the outer circumferential piece, the inner circumferential piece, and the side wall portion is a storage portion of a winding wire, a curved portion is formed between the outer circumferential piece and the side wall portion, and a first inclination surface that extends from an outer surface of the side wall portion to an outer circumferential side in a teeth portion radial direction at an obtuse angle, a step surface that extends along the teeth portion axis direction from a front end of the first inclination surface to an opposite side of the storage portion, and a second inclination surface that extends in parallel with the first inclination surface from a front end of the step surface to an outer circumferential side in the teeth portion radial direction are formed on an inner surface of the curved portion that faces a storage portion side.

### CROSS-REFERENCE TO RELATED APPLICATION

Priority is claimed on Japanese Patent Application No. 2023-152738, filed on Sep. 20, 2023, the contents of which are incorporated herein by reference.

### BACKGROUND

### Field of the Invention

The present invention relates to an insulator structure.

### Background

In recent years, efforts intended to realize a low carbon society or a decarbonized society have been made, and in order to reduce CO2 emissions and improve an energy efficiency even in vehicles, research and development relating to electrification techniques has been conducted.

For example, in a dynamoelectric machine of a vehicle drive motor or the like, a winding wire field type may be employed although the mainstream is an embedded magnet type. In the winding wire field type motor, a coil is arranged on a rotor in place of a permanent magnet, and by causing a current to flow through the coil, a magnetic flux is generated at the rotor. In the winding wire field type motor, by enabling adjustment of a magnetic flux amount of the rotor, a highly efficient operation is expected, and by using no permanent magnet, there is also no concern on the stable supply of rare earth.

That is, at least one of a stator and the rotor of the motor includes an annular portion having an annular shape, a plurality of cores (teeth portions) that radially protrude to an inside or an outside in a radial direction of the annular portion; and a coil in which a conductor wire is wound around an outer circumference of each core.

For example, Japanese Unexamined Patent Application, First Publication No. 2007-135360 discloses that a step having a specific height is provided on a surface (specifically, a surface of an insulator) of a teeth portion in order to enhance a space factor of the conductor wire in a slot between the cores.

### SUMMARY

In the related art described above, an outer circumferential piece and an inner circumferential piece that have a flange shape are provided on both sides in an axis directional sides of the teeth portion, and between the outer circumferential piece and the inner circumferential piece, a winding wire of the coil is stored a lamination state. In the outer circumferential piece and the inner circumferential piece, facing surfaces having a planar shape orthogonal to a teeth portion axis direction face each other in the teeth portion axis direction. On the other hand, the conductor wire that constitutes the winding wire may be curved due to the line habit, and there is a possibility that the adhesiveness to the teeth portion is impaired, or the alignment property is degraded.

An aspect of the present invention aims to provide an insulator structure capable of improving the adhesiveness of a winding wire to a teeth portion and improving a space factor. Further, the aspect of the present invention contributes to the improvement of energy efficiency.

An insulator structure according to a first aspect of the present invention is a structure of an insulator mounted on each of a plurality of teeth portions aligned in a motor circumferential direction, including: an outer circumferential piece that is provided on a first end side in a teeth portion axis direction along a motor radial direction in a teeth portion among the plurality of teeth portions and protrudes to an outer circumferential side when seen from the teeth portion axis direction; an inner circumferential piece that is provided on a second end side in the teeth portion axis direction in the teeth portion, protrudes to the outer circumferential side when seen from the teeth portion axis direction, and faces the outer circumferential piece in the teeth portion axis direction; and a side wall portion that covers an outer circumference of the teeth portion when seen from the teeth portion axis direction and connects the outer circumferential piece to the inner circumferential piece, wherein a space surrounded by a first facing surface of the outer circumferential piece that faces an inner circumferential piece side, a second facing surface of the inner circumferential piece that faces an outer circumferential piece side, and an outer surface of the side wall portion is a storage portion of a winding wire, a curved portion that forms an arc shape protruding to an opposite side of the storage portion is formed between the outer circumferential piece and the side wall portion in a cross section along the teeth portion axis direction, and a first inclination surface that extends from the outer surface of the side wall portion to an outer circumferential side in a teeth portion radial direction at an obtuse angle with respect to the outer surface, a step surface that extends along the teeth portion axis direction from a front end of the first inclination surface to an opposite side of the storage portion in the teeth portion axis direction, and a second inclination surface that extends in parallel with the first inclination surface from a front end of the step surface to an outer circumferential side in the teeth portion radial direction are formed on an inner surface of the curved portion that faces a storage portion side.

According to this configuration, by forming the curved portion that forms an arc shape protruding to the opposite side of the storage portion between the outer circumferential piece on the first end side in the teeth portion axis direction and the side wall portion along the teeth portion axis direction, it becomes easy to avoid stress concentration between the outer circumferential piece and the side wall portion. In a portion (a portion where an inclination angle with respect to the side wall portion is gentle) of the curved portion that begins to stand from the side wall portion to an outer side in the teeth portion radial direction, by including the step surface along the teeth portion axis direction while forming the inclination surface that partially ensures a standing angle, it is possible to gently reduce the inclination angle of the standing portion with respect to the side wall portion. A space around which a winding wire can be wound can be enlarged in the teeth portion axis direction along the step surface. The inclination angle relative to a side wall surface of the inclination surface is set, for example, to an angle along a tangent line of an end portion in the teeth portion axis direction of the winding wires that are stacked in a bale form. Thereby, generation of a dead space at the end portion in the teeth portion axis direction of the winding wire is prevented.

In this way, in a side wall portion side of the curved portion, by providing a shape in which the inclination surface having a taper shape and the step surface along the teeth portion axis direction are combined, a space in which the winding wire can be wound inside the storage portion is enlarged at the standing portion of the curved shape, and it is possible to increase the number of windings.

Then, by dropping the winding wire to a bottom surface (outer surface) of the storage portion while pressing the winding wire on the inclination surface having a taper shape by a tensile force of the winding wire, it becomes possible to wind the winding wire without a gap to the outer circumferential piece in the teeth portion axis direction, and it is possible to improve the adhesiveness of the winding wire and improve a space factor (a ratio occupied by the winding wire with respect to the space inside the storage portion).

A second aspect of the present invention is the insulator structure according to the first aspect described above, wherein the winding wire may be constituted of a conductor wire having a circular shape in a cross section, be stacked in a bale form in the teeth portion radial direction, and form a plurality of layers, and a height h from the outer surface to the step surface in the teeth portion radial direction may be expressed by the following expression when the maximum diameter of the conductor wire is D, and the number of layers of the winding wire overlapping in the teeth portion radial direction is n.

$$h = D \times ( √ 3 / 2 ) \times ( n - 1 ) + D$$

According to this configuration, in the outer side in the teeth portion radial direction of one layer of the winding wires stacked in a bale form, the step surface can be arranged on an extension of the tangent line that is in contact with a plurality of winding wires. Therefore, a step-up treatment or a step-down treatment of the winding wire in the step surface is not required, and it is possible to reduce the dead space between layers of the winding wire, prevent a winding collapse of an upper layer, and ensure the alignment property of the winding wire.

A third aspect of the present invention is the insulator structure according to the first or second aspect described above, in the cross section along the teeth portion axis direction, an arc shape having a diameter identical to an outer diameter of the winding wire having the circular shape in the cross section and constituting the winding wire may be formed on a corner portion between the inclination surface and the step surface.

According to this configuration, by applying round chamfering at the same diameter as that of the conductor wire on the corner portion between the inclination surface and the step surface, an arc shape that simulates the conductor wire is formed at the corner portion between the step surface and the inclination surface, and a form as if the winding wires are continuously aligned is obtained. Thereby, it is possible to reduce the dead space between the layers of the winding wire, prevent the winding collapse of the upper layer, and ensure the alignment property of the winding wire.

A fourth aspect of the present invention is the insulator structure according to any one of the first to third aspects described above, wherein a distance L from the outer circumferential piece to the inner circumferential piece in the teeth portion axis direction may be expressed by the following expression when a turn number of the winding wire of a first layer is Nt, and an outer diameter of the conductor wire having the circular shape in the cross section and constituting the winding wire is D.

$$L = D \times Nt$$

According to this configuration, by setting the distance from the outer circumferential piece to the inner circumferential piece in the teeth portion axis direction to an integral multiple of the outer diameter of the conductor wire (winding wire), it is possible to reduce the dead space between the layers of the winding wire, prevent the winding collapse of the upper layer, and ensure the alignment property of the winding wire.

A fifth aspect of the present invention is the insulator structure according to any one of the first to fourth aspects described above, wherein the inclination surface may be inclined such that a further outer side in the teeth portion radial direction is located at the outer circumferential piece side in the teeth portion axis direction.

According to this configuration, by the inclination surface being inclined such that the further outer side in the teeth portion radial direction is located at the outer circumferential piece side (an opposite side of the storage portion) in the teeth portion axis direction, an opening of the storage portion on the outer side in the teeth portion radial direction is enlarged, and a winding work of the winding wire can be easily performed.

According to the aspect of the present invention, it is possible to provide an insulator structure capable of improving the adhesiveness of the winding wire to the teeth portion and improving the space factor.

### BRIEF DESCRIPTION OF THE DRAWINGS

FIG. 1 is an exploded perspective view of a motor in an embodiment of the present invention.

FIG. 2 is a plan view of a portion in a circumferential direction of a rotor of the motor when seen from an axis direction and includes a partial cross section.

FIG. 3 is an enlarged view showing a cross-sectional portion of a coil shown in FIG. 2.

FIG. 4 is an enlarged view of a IV portion of FIG. 3.

### DESCRIPTION OF EMBODIMENTS

Hereinafter, an embodiment of the present invention will be described with reference to the drawings.

### <Motor 1>

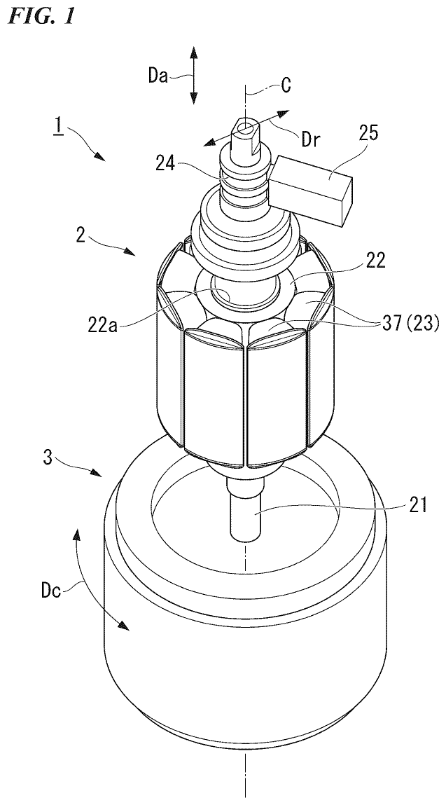

FIG. 1 is an exploded perspective view of a motor (dynamoelectric machine) 1 to which an embodiment of the present invention is applied.

As shown in FIG. 1, the motor 1 includes a rotor 2, a stator 3, and a casing (not shown) that covers the rotor 2 and the stator 3. In the present embodiment, the rotor 2 is arranged on an inner circumferential side relative to the stator 3. That is, the motor 1 is an inner rotor type motor.

The motor 1 of the embodiment is a drive motor for electric vehicles. Further, the motor 1 of the embodiment is a winding wire field type motor and has a rotor structure using a field winding wire (coil 37) instead of a permanent magnet. By causing a direct current to flow through the field winding wire from the outside, the motor 1 generates a magnetic flux at the rotor 2 and enables adjustment of the field magnetic flux.

### <Rotor 2>

The rotor 2 includes a rotation shaft 21, a rotor core 22, a plurality of magnetic pole portions 23, and a commutator 24.

The rotation shaft 21 extends in an axis direction (motor axis direction) Da. The rotation shaft 21 is supported by a casing (not shown) via a bearing (not shown). The rotation shaft 21 is supported rotatably in a circumferential direction (motor circumferential direction) Dc around an axis line C extending in an axis direction Da.

The rotor core 22 is provided on an outer side (outer circumferential side) in a radial direction (motor radial direction) Dr around the axis line C relative to the rotation shaft 21. The rotor core 22 is formed in a cylindrical shape such that the axis line C is an axis center. When seen from the axis direction Da, a shaft insertion hole 22a through which the rotation shaft 21 is inserted is formed on a center portion of the rotor core 22. The rotor core 22 is rotatable in the circumferential direction Dc integrally with the rotation shaft 21.

The plurality of magnetic pole portions 23 are arranged at equal intervals to be spaced apart from each other in the circumferential direction Dc on an outer circumference portion of the rotor core 22. Each magnetic pole portion 23 includes the coil 37. The coil 37 is formed by winding a winding wire 32 via an insulator 38 on an outer circumference of a teeth portion 35 formed on the rotor core 22. Details of the coil 37 and the insulator 38 will be described later.

The commutator 24 is coaxially provided on one end portion of the rotation shaft 21. The commutator 24 is rotatable in the circumferential direction Dc integrally with the rotation shaft 21. A brush 25 that is supported by the casing faces and is in contact with the commutator 24 in a radial direction Dr.

### <Stator 3>

The stator 3 is arranged with a gap (air gap) on an outer circumferential side in the radial direction Dr relative to the rotor core 22. The stator 3 is fixed on an inner circumferential side in the radial direction Dr of the casing. The stator 3 includes a stator core (not shown) and a plurality of magnetic pole portions (not shown).

### <Details of Rotor 2>

Hereinafter, the rotor 2 is described in more detail.

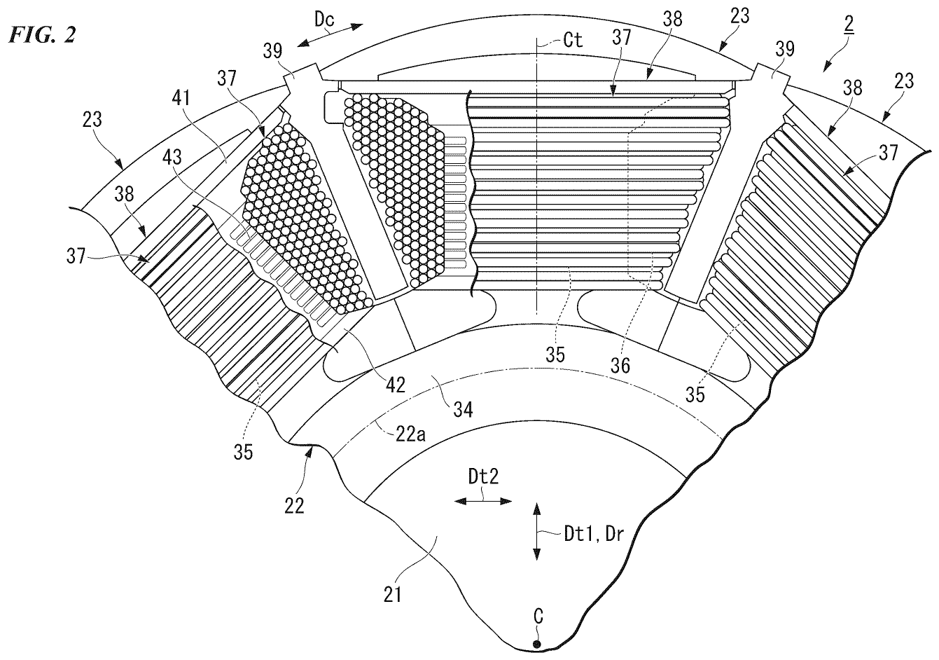

As shown in FIG. 2, the rotor core 22 integrally includes an annular portion 34 and a plurality of teeth portions 35.

The annular portion 34 is formed on an inner circumferential side (rotation shaft 21 side) of the rotor core 22. The annular portion 34 extends in the circumferential direction Dc and is formed in an annular shape when seen from the axis direction Da.

The plurality of teeth portions 35 are formed at equal intervals to be spaced apart from each other in the circumferential direction Dc. Each teeth portion 35 extends from an outer circumference section of the annular portion 34 along the radial direction Dr to an outer circumferential side. A slot 36 is formed between the teeth portions 35 adjacent to each other in the circumferential direction Dc. The slot 36 is in a form in which the outer circumferential side of the rotor core 22 is cut out.

The number of the formed slot 36 and the formed teeth portion 35 is the same (eight in the embodiment) as each other. The rotor core 22 may have a configuration that can be divided in the circumferential direction Dc for each of the plurality of teeth portions 35. A line Ct in FIG. 2 represents a center axis line along a center axis line (a protrusion direction (motor radial direction Dr) of the teeth portion 35) of the teeth portion 35. Hereinafter, a protrusion direction of the teeth portion 35 is referred to as a teeth portion axis direction Dt1, and a direction orthogonal to the teeth portion axis direction Dt1 is referred to as a teeth portion radial direction Dt2.

The winding wire 32 is a conductor wire (for example, a copper wire) and is held by the rotor core 22 in a form of the coil 37. The winding wire 32 is wound around each of the plurality of teeth portions 35 via an insulator 38 made of an insulating resin. The winding wire 32 is wound such that a plurality of layers 32a are laminated on an outer circumference of the teeth portion 35 when seen from the teeth portion axis direction Dt1. The winding wire 32 is wound around each teeth portion 35, and thereby, a plurality of coils 37 that are aligned to be spaced apart from each other in the circumferential direction Dc are formed on the rotor 2. A slot pole (insulation plate) 39 made of an insulating resin is inserted between the pair of coils 37 that are adjacent to each other in the circumferential direction Dc.

### <Insulator 38>

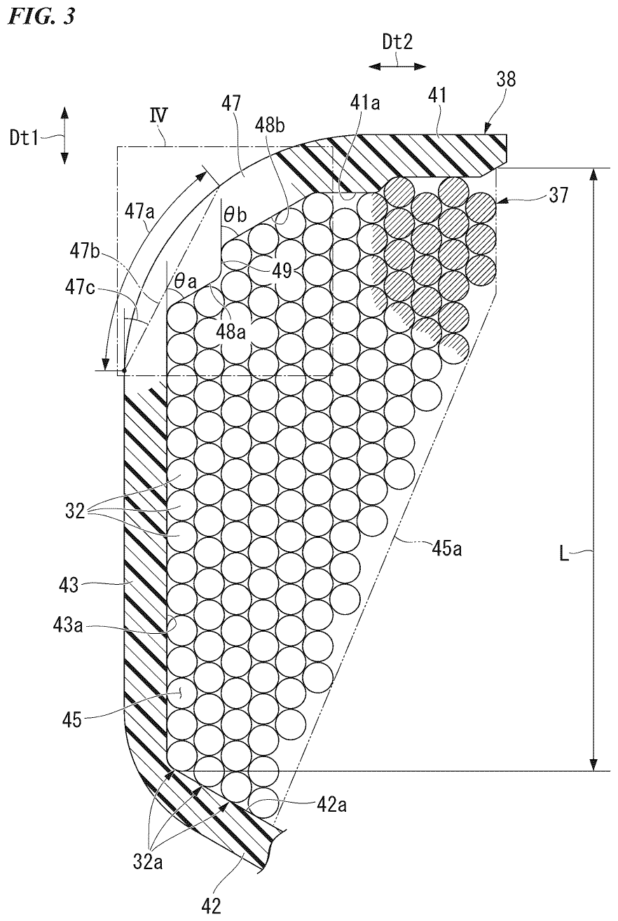

As shown in FIG. 2 and FIG. 3, the insulator 38 of the embodiment includes: an outer circumferential piece 41 that has a flange shape and is provided on a first end side (motor outer circumferential side) in the teeth portion axis direction Dt1; an inner circumferential piece 42 that has a flange shape and is provided on a second end side (motor inner circumferential side) in the teeth portion axis direction Dt1; and a side wall portion 43 that has a cylindrical shape and connects the outer circumferential piece 41 and the inner circumferential piece 42 to each other. An inner space surrounded from three sides by facing surfaces 41a, 42a of the outer circumferential piece 41 and the inner circumferential piece 42 and an outer surface 43a of the side wall portion 43 is a storage portion 45 that stores the coil 37 in which the winding wires 32 are laminated. The slot 36 is formed of a pair of storage portions 45 that are adjacent to each other in the motor circumferential direction Dc.

The winding wires 32 are densely arranged by being stacked in a so-called bale form in the storage portion 45. A two-dot chain line 45a in FIG. 3 is an imaginary line extending between outer end portions in the teeth portion radial direction of the outer circumferential piece 41 and the inner circumferential piece 42 and represents an outer shape on the outside in the teeth portion radial direction in the storage portion 45.

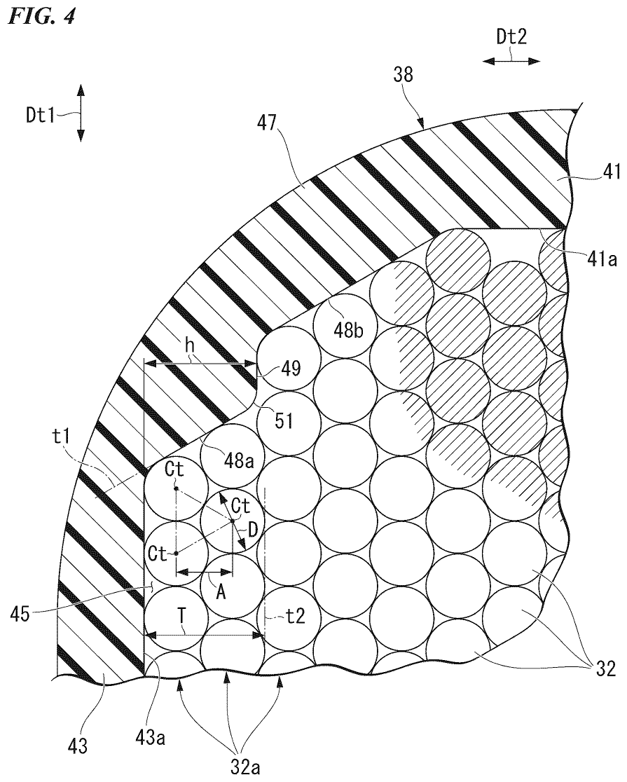

Cross sections shown in part of FIG. 2, FIG. 3, and FIG. 4 show a cross section (a cross section that passes through the center axis line Ct) along the teeth portion axis direction Dt1 in the coil 37 and the insulator 38. Hereinafter, these cross sections may be referred to as a “cross section shown in each drawing”.

As shown in FIG. 3, a curved portion 47 that is curved in an arc shape is formed on a corner portion between the outer circumferential piece 41 and the side wall portion 43 in the cross section shown in each drawing. A plurality of (for example, two) inclination surfaces 48a, 48b (a first inclination surface 48a, a second inclination surface 48b) are formed on an inner circumferential side of the curved portion 47. The plurality of inclination surfaces 48a, 48b extend to have the same inclination angles θa, θb toward the outer side in the teeth portion radial direction in the cross section shown in each drawing. A step surface 49 that extends linearly along the teeth portion axis direction Dt1 is formed between the plurality of inclination surfaces 48a, 48b in the cross section shown in each drawing.

The winding wire 32 of a layer 32a (first layer) closest to the side wall portion 43 is wound while being pressed against the outer surface 43a of the side wall portion 43 by a tensile force at the time of a winding work. A distance L in the teeth portion axis direction Dt1 between the outer circumferential piece 41 and the inner circumferential piece 42 is set to an integral multiple of an outer diameter (diameter) D of the conductor wire that constitutes the winding wire 32 as described later. Thereby, the winding wire 32 is wound while being pressed to the inside in the teeth portion radial direction, and the winding wires 32 are aligned without a gap in the teeth portion axis direction Dt1.

By connecting the plurality of inclination surfaces 48a, 48b via the step surface 49 along the teeth portion axis direction Dt1, in a portion (a portion where an inclination angle 47c with respect to the side wall portion 43 is gentle, hereinafter, referred to as a standing portion 47a) of the curved portion 47 that begins to stand from the side wall portion 43 to an outer side in the teeth portion radial direction, the following action is achieved. That is, in the standing portion 47a of the curved portion 47, by providing the step surface 49 along the teeth portion axis direction Dt1 between the plurality of inclination surfaces 48a, 48b, it is possible to gently reduce the inclination angle 47c of the standing portion 47a with respect to the side wall portion 43 while forming the plurality of inclination surfaces 48a, 48b that partially ensure standing angles (inclination angles) θa, θb.

The “portion that begins to stand from the side wall portion 43 to an outer side in the teeth portion radial direction” of the curved portion 47 is, for example, a range of about a half circumference of the curved portion 47 on the side wall portion 43 side in the cross section shown in each drawing. Further, “the inclination angle 47c with respect to the side wall portion 43” of the standing portion 47a is, for example, an inclination angle of a straight line 47b that connects an end section of the standing portion 47a on the side wall portion 43 side to an outer end section in the teeth portion radial direction in the cross section shown in each drawing.

As shown in FIG. 4, the plurality of inclination surfaces 48a, 48b are formed in parallel with a first tangent line t1 that is in contact with the plurality of windings wires 32 at one end portion in the teeth portion axis direction of the winding wires 32 that are stacked in a bale form. Even when the number of layers of the winding wire 32 is increased, each inclination surface 48a, 48b is in contact with the winding wire 32 at one end portion in the teeth portion axis direction of each layer 32a. The winding wire 32 at one end portion in the teeth portion axis direction of each layer 32a is arranged along each inclination surface 48a, 48b. Thereby, a dead space at one end portion in the teeth portion axis direction of each layer 32a is reduced.

As shown in FIG. 4, when the winding wires 32 having a circular shape in a cross section are stacked in a bale form, the plurality of winding wires 32 are stacked in an equilateral triangle shape at locations of the coil 37. In a pair of layers 32a that overlap each other, a distance A in the teeth portion radial direction Dt2 between axis centers 32c of the winding wires 32 of respective layers 32a is expressed by Expression (1) described below.

$$A = √ 3 \cdot D / 2 = ( √ 3 / 2 ) \cdot D ( D is a maximum diameter ( outer diameter ) of the winding wire 32 ) \qquad ( 1 )$$

A height T in the teeth portion radial direction Dt2 of two layers of winding wires 32 that are stacked in a bale form is T=A+D.

When the number of layers increases, for example, T=2·A+D for three layers of winding wires 32, and T=3·A+D for four layers of winding wires 32. That is, a height T in the teeth portion radial direction Dt2 of a plurality of layers of winding wires 32 is expressed by Expression (2) described below.

$$T = ( n - 1 ) A + D = ( n - 1 ) \cdot ( √ 3 / 2 ) \cdot D + D ( n is the number of layers of winding wires 32 ( natural number ) ) \qquad ( 2 )$$

In the embodiment, a height h in the teeth portion radial direction Dt2 from the outer surface 43a of the side wall portion 43 to the step surface 49 is set to the height T shown by Expression (2) described above.

Thereby, the height T of the step surface 49 and the height of a second tangent line t2 in contact with any of the layers 32a of the winding wires 32 that are stacked in a bale form from the outer side in the teeth portion radial direction becomes the same height as each other. The step surface 49 and a surface along the second tangent line t2 are continuously flush with each other. Accordingly, when the winding wire 32 is further wound at a further outer side in the teeth portion radial direction than the height T of the step surface 49, the winding wire 32 is wound on a plane at the same height in the teeth portion radial direction Dt2 including the step surface 49. As a result, the outer circumferential surface of the coil 37 is formed to be flush.

In a cross section along the teeth portion axis direction Dt1, round chamfering that forms an arc shape 51 having the same diameter as the outer diameter of the winding wire 32 is applied to a corner portion between the step surface 49 and the inclination surface 48a. Thereby, a simulated winding wire 32 is present at the corner portion between the step surface 49 and the inclination surface 48a, and a form as if the winding wires 32 are continuously aligned on the plane at the same height as the step surface 49 is obtained. Thereby, when the winding wire 32 is wound on the plane at the same height as the step surface 49, the layer 32a of the winding wire 32 can be easily formed to be flush to the step surface 49.

In the cross section along the teeth portion axis direction Dt1, the step surface 49 of the embodiment extends linearly along the teeth portion axis direction Dt1; however, the embodiment is not limited to this configuration. For example, the step surface 49 may be formed in a wave shape having a recess shape along the outer diameter of the winding wire 32 in the cross section along the teeth portion axis direction Dt1. In this case, the adhesiveness to the step surface 49 of the winding wire 32 on the step surface 49 is enhanced, and it becomes easier to form the layer 32a of the winding wire 32 on the plane at the same height as the step surface 49 to be flush.

As shown in FIG. 3, a length L between the inner circumferential piece 42 and the outer circumferential piece 41 in the teeth portion axis direction Dt1 is expressed by Expression (3) described below.

$$L = D \cdot Nt ( Nt is a turn number of the winding wire 32 of the first layer ( natural number ) ) \qquad ( 3 )$$

Thereby, by winding the winding wire 32 of the first layer by a prescribed turn number by a prescribed tensile force, the winding wire 32 of the first layer is aligned without a gap in the teeth portion axis direction Dt1 between the inner circumferential piece 42 and the outer circumferential piece 41. Therefore, it is possible to reduce a dead space around the first layer and improve a space factor of the winding wire 32.

Each inclination surface 48a, 48b is inclined such that a further outer side in the teeth portion radial direction is located at an outer side in the teeth portion axis direction (a side toward the outer circumferential piece 41 from a middle in the teeth portion axis direction of the insulator 38). Thereby, a turn number of the winding wire 32 is increased in the teeth portion axis direction Dt1 in the layer 32a on a further outer side in the teeth portion radial direction. Further, since the storage portion 45 is enlarged in the teeth portion axis direction Dt1 toward the outer side in the teeth portion radial direction, a winding work of the winding wire is easily performed.

In the cross section along the teeth portion axis direction Dt1, the inclination angle θa, θb of each inclination surface 48a, 48b with respect to the outer surface 43a (teeth portion axis direction Dt1) of the side wall portion 43 is set to 60 degrees (an angle along the winding wire distribution of the stack in a bale form). Thereby, the winding wire 32 of each layer 32a is arranged so as to be in contact with each inclination surface 48a, 48b of 60 degrees at one end portion in the teeth portion axis direction of the winding wire 32 stacked in a bale form while reducing the dead space between the layers of the winding wire 32 by the stack in a bale form, and thereby, it is possible to reduce the dead space at one end portion in the teeth portion axis direction of the winding wire 32. Accordingly, the adhesiveness of the winding wire 32 can be improved, and at the same time, the space factor can be improved.

The embodiment is described using a configuration that includes two inclination surfaces 48a, 48b and a single step surface 49 formed between the two inclination surfaces 48a, 48b; however, the embodiment is not limited to this configuration. For example, a configuration may be employed which includes three or more inclination surfaces and two or more step surfaces formed between two inclination surfaces that are adjacent to each other. Also in this case, the inclination angle θa, θb of each inclination surface with respect to the outer surface 43a (teeth portion axis direction Dt1) can be preferably 60 degrees.

The facing surface 42a of the inner circumferential piece 42 is an inclination surface inclined such that a further outer side in the teeth portion radial direction is located at the outer side in the teeth portion axis direction (a side toward the inner circumferential piece 42 from a middle in the teeth portion axis direction of the insulator 38). Similarly to each inclination surface 48a, 48b of the outer circumferential piece 41, the inclination surface of the inner circumferential piece 42 is formed in parallel with a tangent line that is in contact with the plurality of winding wires 32 at another end portion in the teeth portion axis direction of the winding wires 32 stacked in a bale form. Further, the inclination surface of the inner circumferential piece 42 is set such that an inclination angle with respect to the outer surface 43a (teeth portion axis direction Dt1) of the side wall portion 43 is 60 degrees.

As described above, the insulator structure in the embodiment described above is a structure of an insulator 38 mounted on each of a plurality of teeth portions 35 aligned in a motor circumferential direction Dc, including: an outer circumferential piece 41 that is provided on a first end side in a teeth portion axis direction Dt1 along a motor radial direction Dr in a teeth portion 35 and protrudes to an outer circumferential side when seen from the teeth portion axis direction Dt1; an inner circumferential piece 42 that is provided on a second end side in the teeth portion axis direction Dt1 in the teeth portion 35, protrudes to the outer circumferential side when seen from the teeth portion axis direction Dt1, and faces the outer circumferential piece 41 in the teeth portion axis direction Dt1; and a side wall portion 43 that covers an outer circumference of the teeth portion 35 when seen from the teeth portion axis direction Dt1 and connects the outer circumferential piece 41 to the inner circumferential piece 42, wherein a space surrounded by a first facing surface 41a of the outer circumferential piece 41 that faces an inner circumferential piece 42 side, a second facing surface 42a of the inner circumferential piece 42 that faces an outer circumferential piece 41 side, and an outer surface 43a of the side wall portion 43 is a storage portion 45 of a winding wire 32, a curved portion 47 that forms an arc shape protruding to an opposite side of the storage portion 45 is formed between the outer circumferential piece 41 and the side wall portion 43 in a cross section along the teeth portion axis direction Dt1, and a first inclination surface 48a that extends from the outer surface 43a of the side wall portion 43 to an outer circumferential side in a teeth portion radial direction Dt2 at an obtuse angle with respect to the outer surface 43a, a step surface 49 that extends along the teeth portion axis direction Dt1 from a front end of the first inclination surface 48a to an opposite side of the storage portion 45 in the teeth portion axis direction Dt1, and a second inclination surface 48b that extends in parallel with the first inclination surface 48a from a front end of the step surface 49 to an outer circumferential side in the teeth portion radial direction Dt2 are formed on an inner surface of the curved portion 47 that faces a storage portion 45 side.

According to this configuration, by forming the curved portion 47 that forms an arc shape protruding to the opposite side of the storage portion 45 between the outer circumferential piece 41 on the first end side in the teeth portion axis direction and the side wall portion 43 along the teeth portion axis direction Dt1, it becomes easy to avoid stress concentration between the outer circumferential piece 41 and the side wall portion 43. In a portion (a portion where an inclination angle 47c with respect to the side wall portion 43 is gentle) of the curved portion 47 that begins to stand from the side wall portion 43 to an outer side in the teeth portion radial direction, by including the step surface 49 along the teeth portion axis direction Dt1 while forming the inclination surface 48a, 48b that partially ensures a standing angle θa, θb, it is possible to gently reduce the inclination angle 47c of the standing portion 47a with respect to the side wall portion 43. A space around which a winding wire 32 can be wound can be enlarged in the teeth portion axis direction Dt1 along the step surface 49. The inclination angle θa, θb relative to a side wall surface of the inclination surface 48a, 48b is set, for example, to an angle along a tangent line t1 of an end portion in the teeth portion axis direction of the winding wires 32 that are stacked in a bale form.

Thereby, generation of a dead space at the end portion in the teeth portion axis direction of the winding wire 32 is prevented.

In this way, in a side wall portion 43 side of the curved portion 47, by providing a shape in which the inclination surface 48a, 48b having a taper shape and the step surface 49 along the teeth portion axis direction Dt1 are combined, a space in which the winding wire can be wound inside the storage portion 45 is enlarged at the standing portion 47a of the curved shape, and it is possible to increase the number of windings.

Then, by dropping the winding wire 32 to a bottom surface (outer surface 43a) of the storage portion 45 while pressing the winding wire 32 on the inclination surface 48a, 48b having a taper shape by a tensile force of the winding wire 32, it becomes possible to wind the winding wire 32 without a gap to the outer circumferential piece 41 in the teeth portion axis direction Dt1, and it is possible to improve the adhesiveness of the winding wire 32 and improve a space factor (a ratio occupied by the winding wire 32 with respect to the space inside the storage portion 45).

In the insulator structure described above, the winding wire 32 is constituted of a conductor wire having a circular shape in a cross section, is stacked in a bale form in the teeth portion radial direction Dt2, and forms a plurality of layers 32a, and a height h from the outer surface 43a to the step surface 49 in the teeth portion radial direction Dt2 is expressed by the following expression when a maximum diameter of the conductor wire is D, and a number of layers of the winding wire 32 overlapping in the teeth portion radial direction Dt2 is n.

$$h = D \times ( √ 3 / 2 ) \times ( n - 1 ) + D$$

According to this configuration, in the outer side in the teeth portion radial direction of one layer 32a of the winding wires 32 stacked in a bale form, the step surface 49 can be arranged on an extension of the tangent line t2 that is in contact with a plurality of winding wires 32.

Therefore, a step-up treatment or a step-down treatment of the winding wire 32 in the step surface 49 is not required, and it is possible to reduce the dead space between layers of the winding wire 32, prevent a winding collapse of an upper layer, and ensure the alignment property of the winding wire 32.

In the insulator structure described above, in the cross section along the teeth portion axis direction Dt1, an arc shape 51 having a diameter identical to an outer diameter of the winding wire having the circular shape in the cross section and constituting the winding wire 32 is formed on a corner portion between the inclination surface 48a and the step surface 49.

According to this configuration, by applying round chamfering at the same diameter as that of the conductor wire on the corner portion between the inclination surface 48a and the step surface 49, an arc shape 51 that simulates the conductor wire is formed at the corner portion between the step surface 49 and the inclination surface 48a, and a form as if the winding wires 32 are continuously aligned is obtained. Thereby, it is possible to reduce the dead space between the layers of the winding wire 32, prevent the winding collapse of the upper layer, and ensure the alignment property of the winding wire 32.

In the insulator structure described above, a distance L from the outer circumferential piece 41 to the inner circumferential piece 42 in the teeth portion axis direction Dt1 is expressed by the following expression when a turn number of the winding wire 32 of a first layer is Nt, and an outer diameter of the conductor wire having the circular shape in the cross section and constituting the winding wire 32 is D.

$$L = D \times Nt$$

According to this configuration, by setting the distance L from the outer circumferential piece 41 to the inner circumferential piece 42 in the teeth portion axis direction Dt1 to an integral multiple of the outer diameter of the conductor wire (winding wire 32), it is possible to reduce the dead space between the layers of the winding wire, prevent the winding collapse of the upper layer, and ensure the alignment property of the winding wire 32.

In the insulator structure described above, the inclination surface 48a, 48b is inclined such that a further outer side in the teeth portion radial direction is located at the outer circumferential piece 41 side in the teeth portion axis direction Dt1.

According to this configuration, by the inclination surface 48a, 48b being inclined such that the further outer side in the teeth portion radial direction is located at the outer circumferential piece 41 side (an opposite side of the storage portion 45) in the teeth portion axis direction Dt1, an opening of the storage portion 45 on the outer side in the teeth portion radial direction is enlarged, and a winding work of the winding wire 32 can be easily performed.

The present invention is not limited to the embodiment described above. For example, the insulator structure of the embodiment may be applied to a dynamoelectric machine other than a vehicle drive motor. For example, the dynamoelectric machine shown in the embodiment as an example is an inner rotor type motor; however, the present invention is not limited to this configuration. For example, the dynamoelectric machine may be an outer rotor type machine in which the rotor is arranged on an outer circumferential side relative to the stator. Further, the dynamoelectric machine is not limited to the motor and may be a generator. The present invention may be applied not to the insulator of the rotor but to an insulator of the stator.

The configuration in the embodiment described above is an example of the present invention, and various changes can be made without departing from the scope of the present invention such as substitutions of the components of the embodiment with well-known components.

What is claimed is:

1. An insulator structure which is a structure of an insulator mounted on each of a plurality of teeth portions aligned in a motor circumferential direction, comprising:
an outer circumferential piece that is provided on a first end side in a teeth portion axis direction along a motor radial direction in a teeth portion among the plurality of teeth portions and protrudes to an outer circumferential side when seen from the teeth portion axis direction;
an inner circumferential piece that is provided on a second end side in the teeth portion axis direction in the teeth portion, protrudes to the outer circumferential side when seen from the teeth portion axis direction, and faces the outer circumferential piece in the teeth portion axis direction; and
a side wall portion that covers an outer circumference of the teeth portion when seen from the teeth portion axis direction and connects the outer circumferential piece to the inner circumferential piece,
wherein a space surrounded by a first facing surface of the outer circumferential piece that faces an inner circumferential piece side, a second facing surface of the inner circumferential piece that faces an outer circumferential piece side, and an outer surface of the side wall portion is a storage portion of a winding wire,
a curved portion that forms an arc shape protruding to an opposite side of the storage portion is formed between the outer circumferential piece and the side wall portion in a cross section along the teeth portion axis direction, and
a first inclination surface that extends from the outer surface of the side wall portion to an outer circumferential side in a teeth portion radial direction at an obtuse angle with respect to the outer surface,
a step surface that extends along the teeth portion axis direction from a front end of the first inclination surface to an opposite side of the storage portion in the teeth portion axis direction, and
a second inclination surface that extends in parallel with the first inclination surface from a front end of the step surface to an outer circumferential side in the teeth portion radial direction
are formed on an inner surface of the curved portion that faces a storage portion side.

2. The insulator structure according to claim 1,
wherein the winding wire is constituted of a conductor wire having a circular shape in a cross section, is stacked in a bale form in the teeth portion radial direction, and forms a plurality of layers, and
a height h from the outer surface to the step surface in the teeth portion radial direction is expressed by the following expression when a maximum diameter of the conductor wire is D, and a number of layers of the winding wire overlapping in the teeth portion radial direction is n,
$$h = D \times ( √ 3 / 2 ) \times ( n - 1 ) + D . \qquad Expression$$

3. The insulator structure according to claim 1,
wherein in the cross section along the teeth portion axis direction, an arc shape having a diameter identical to an outer diameter of the winding wire having the circular shape in the cross section and constituting the winding wire is formed on a corner portion between the inclination surface and the step surface.

4. The insulator structure according to claim 1,
wherein a distance L from the outer circumferential piece to the inner circumferential piece in the teeth portion axis direction is expressed by the following expression when a turn number of the winding wire of a first layer is Nt, and an outer diameter of the conductor wire having the circular shape in the cross section and constituting the winding wire is D,
$$L = D \times Nt . \qquad Expression$$

5. The insulator structure according to claim 1,
wherein the inclination surface is inclined such that a further outer side in the teeth portion radial direction is located at the outer circumferential piece side in the teeth portion axis direction.

6. The insulator structure according to claim 2,
wherein in the cross section along the teeth portion axis direction, an arc shape having a diameter identical to an outer diameter of the winding wire having the circular shape in the cross section and constituting the winding wire is formed on a corner portion between the inclination surface and the step surface.

7. The insulator structure according to claim 2,
wherein a distance L from the outer circumferential piece to the inner circumferential piece in the teeth portion axis direction is expressed by the following expression when a turn number of the winding wire of a first layer is Nt, and an outer diameter of the conductor wire having the circular shape in the cross section and constituting the winding wire is D,
$$L = D \times Nt . \qquad Expression$$

8. The insulator structure according to claim 2,
wherein the inclination surface is inclined such that a further outer side in the teeth portion radial direction is located at the outer circumferential piece side in the teeth portion axis direction.
